(19) United States
(12) Patent Application Publication
(10) Pub. No.: US 2008/0300730 A1
(43) Pub. Date: Dec. 4, 2008

(54) Roller-ball roller coaster

(76) Inventor: Joseph M. Cleary, Cold Spring, KY (US)

Correspondence Address: David E. Orr, 4616 NE 134TH Street, Vancouver, WA, 98686, US

(21) Appl. No.: 11/810,347

(22) Filed: Jun. 4, 2007

(51) Int. Cl. A63G 7/00; G05D 1/00

(52) U.S. Cl. 701/1; 104/53

(57) ABSTRACT

A novel roller coaster comprising a spherical, rotating rider-enclosure, wherein the roller coaster is transported along or within a track configured to transport the coaster, while converting coaster kinetic energy from potential energy and back. The rider is subjected to accelerations resulting from the coaster's transport, among which are rotational accelerations resulting from the rider enclosure. In a preferred embodiment, the coaster comprises a transport mechanism, the transport mechanism engaging and following a track. The spherical enclosure further includes a gimbal arrangement having a gyroscope, the gimbal arrangement supported by the transport mechanism. The gimbal arrangement contains at least one seat carrying a rider, and the motion of the rider is determined by the gyroscope that is controlled by a computer within the coaster. Therefore the motion of the rider is determined by the path of the transport mechanism and the rotation of the rider compartment under the computer controlled gyroscope. The spherical enclosure may roll within a track or the spherical enclosure may be attached to and carried by a traditional roller coaster conveyance.

### FIELD

The present invention is related to the field of amusement rides; more specifically the present invention is a novel roller coaster ride wherein the rider occupies a rotating spherical apparatus controlled by a computer.

### BACKGROUND

The roller coaster is a ride designed for amusement parks and modem theme parks. LaMarcus Thompson patented the first roller coaster on Jan. 20, 1885. An estimated 290 million people flock to amusement parks annually to experience this sensation. In 1999, Pittsburgh's Kennywood Park hosted ore than a million people with 1,800 of them riding the Steel Phantom, the park's largest coaster, every hour.

Basically a specialized railroad system, a roller coaster consists of a track that rises and falls in specially designed patterns, sometimes with one or more inversions, such as loops, that briefly turns the rider briefly upside down. A coaster track does not have to be a complete circuit, though some aficionados would disagree. The coaster tracks serve to channel this force—they control the way the coaster cars fall. If the tracks slope down, gravity pulls the front of the car toward the ground, so it accelerates. If the tracks tilt up, gravity applies a downward force on the back of the coaster, so it decelerates.

A roller coaster's energy is constantly changing between potential and kinetic energy. At the top of a hill formed by the track, there is maximum potential energy because the train is as high as it gets. As the coaster starts down the hill, this potential energy is converted into kinetic energy—the coaster speeds up. At the bottom of the hill, there is maximum kinetic energy and little potential energy. The kinetic energy propels the coaster up the second hill, building up the potential-energy level. As the coaster enters a loop, it has a lot of kinetic energy and not much potential energy. The potential-energy level builds as the coaster speeds to the top of the loop, but it is soon converted back to kinetic energy as the coaster exits the loop.

Most coasters have cars for two, four, or six passengers each, in which the passengers sit to travel around the circuit. An entire set of connected cars is called a train. Some roller coasters, notably Wild Mouse roller coasters, run with single cars.

The cars on a typical roller coaster are not self-powered. Instead, a standard full-circuit lift-powered coaster is pulled up with a chain or cable along the lift hill to the first peak of the coaster track. Then potential energy becomes kinetic energy as the cars race down the first downward slope. Kinetic energy is converted back into potential energy as the train moves up again to the second peak. This is necessarily lower as some mechanical energy is lost due to friction. Then the train goes down again, and up, and so on.

However, not all coasters run this way. The train may be set into motion by a launch mechanism such as a flywheel, linear induction motors, linear synchronous motors, hydraulic launch, compressed air launch, drive tire, etc. Some coasters move back and forth along the same section of track; these roller coasters are called shuttles because of this motion and usually run the circuit once with riders moving forwards and then backwards through the same course. Some roller coasters are powered by a prime mover such as a locomotive. A properly designed roller coaster under good conditions will have enough kinetic, or moving, energy to complete the entire course, at the end of which brakes bring the train to a complete stop and it is pushed into the station. A brake run at the end of the circuit is the most common method of bringing the roller coaster ride to a stop.

Roller coasters are made using a variety of designs. Some designs are based upon how the rider is positioned to experience the ride. Traditionally, coaster riders sit facing forward in the coaster car, while newer coaster designs have ignored this tradition in the quest for building more exciting, unique ride experiences for the riders. In some rides the passenger sits in a frame, wherein the passenger's legs dangling in the air and providing a less obstructed view of the ground, thus providing additional fright to the passengers. In another variation riders are placed in a standing position restrained by heavy straps. In some roller coasters passengers sit in the opposite direction to their travel.

In addition to changing the rider's viewpoint, coaster designs also focus on track styles to make the ride fresh and different from other coasters. One method of designing a coaster is to select one item from each of the different coaster options: height, rider experience, track design, and launch mechanics. These four elements combine to make a unique coaster for the park.

While there are hundreds of different coaster designs, the insatiable attraction of riders to even more thrilling rides indicate a need for more exotic and scary roller coasters.

### SUMMARY

In response to this need, herein is disclosed a novel roller coaster comprising a spherical, rotating enclosure for a rider, wherein the roller coaster is transported along or within a track, while converting coaster kinetic energy from potential energy and back, whereby the rider is subjected to accelerations resulting from the coaster's taansport. In addition, the enclosure may be propelled, along some part of the ride by a motivating mechanism, such as a linear motor.

In a preferred embodiment, the invention operates as a coaster comprising: (1) a transport mechanism, the transport mechanism engaging and following a track; (2) a gimbal mechanism having a gyroscope, the gimbal mechanism engaged and supported by the transport mechanism, wherein the gimbal mechanism includes at least one seat carrying a rider, the motion of the gimbal mechanism determined by the gyroscope that is controlled by a computer within the coaster; whereby the motion of the rider is determined by the path of the transport mechanism and the rotation of the gimbal mechanism under the computer controlled gyroscope.

In the preferred embodiment, the degree, frequency and extent of the rotational motion of the rider is controlled by the computer. The motion contributed by the computer-controlled gyroscope may be adjusted to meet the safety, comfort and thrill-level required by riders.

In a first elaboration of the preferred embodiment, the transport mechanism is a spherical frame adapted to enclose the gimbal mechanism so that the gimbal mechanism is free to rotate within the sphere. The track is made to securely hold the spherical frame as it rolls along and within the track. The spherical frame may be covered or enclosed by a spherical shell.

In a second elaboration of the preferred embodiment, the transport mechanism is a traditional coaster car adapted to hold and secure the gimbal mechanism, seat, gyroscope and computer. The adaptation is made so the gimbal mechanism under control of the computer and gyroscope may rotate according to the computer program, while the rider is transported along the track.

### Objects

The invention as exemplified by the preferred embodiment and elaborations has several objects and benefits.

A first object is a coaster ride that provides unparalleled thrills to a rider.

A second object is a ride wherein the direction and degree of motion of the rider is controlled by a computer program.

A third object is a ride that may be easily adapted to existing tracks and traditional roller coaster transports.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF DRAWINGS

FIG. 1 shows a gimbal arrangement for practicing the invention.

FIG. 2 shows the gimbal mechanism adapted to, and receiving, a rider compartment.

FIG. 3 illustrates the gimbal mechanism having a computer controlled gyroscope driven by a motor.

FIG. 4A depicts a gyroscope used to control rider motion.

FIG. 4B shows more detail of the gimbal mechanism, the gyroscope rotor and motor powering the gyroscope rotor.

FIG. 5 shows an exemplary computer system for controlling the ride.

FIG. 6 shows the gimbal arrangement mounted in a spherical transport.

FIG. 7A shows the preferred embodiment with the gimbal arrangement held within a spherical cage that rolls within a track.

FIG. 7B shows an alternative embodiment with the gimbal arrangement housed in a cage that is mounted on a traditional roller coaster car.

### DETAILED DESCRIPTION

### Gimbal Mechanism

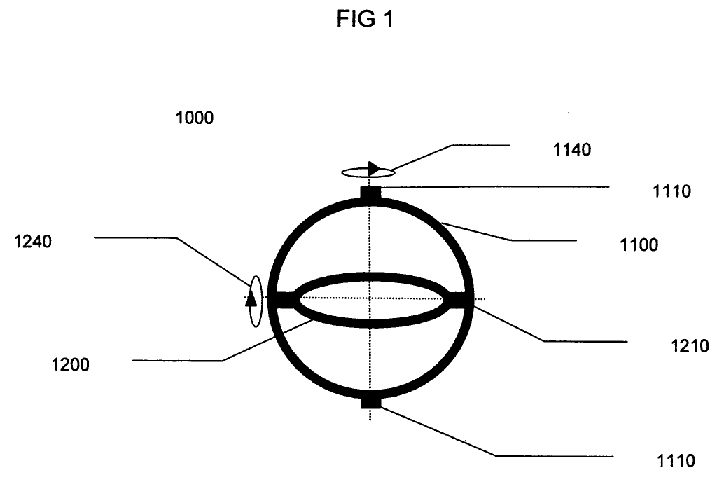

With reference to FIG. 1; the ride includes a gimbal 1000, which is a mechanical device that allows the rotation of an object in multiple dimensions. The gimbal mechanism 1000 has an outer frame 1100 held by mounts or pivots 1110 having bearings configured to permit the outer frame 1100 to rotate about a vertical axis 1140. The outer frame 1100 is configured to receive an inner frame 1200 having mounts or pivots 1210 with bearings made to permit the inner frame 1200 to rotate about a horizontal axis 1240 with respect to the outer frame 1100.

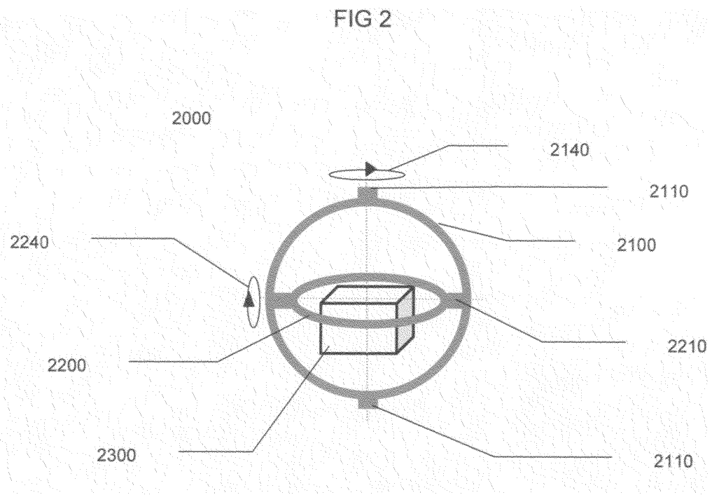

With reference to FIG. 2, the ride further includes a rider compartment 2300, which is mounted inside and fixed to the inner frame 2200, whereby the rider compartment 2300 will rotate with respect to the horizontal axis 2240 simultaneously with the vertical axis 2140. In FIG. 2, the rider compartment 2300 is drawn as a box, whereas it is understood the rider compartment is made to conform with the inner frame 2200 and may be made of any geometrical configuration as long as the center of gravity of the rider compartment 2330 is no higher than the line drawn from the centroid of the mounts or pivots 2210 defining the horizontal axis or rotation 2240. Heighth is vertically referenced to the axis of rotation indicated by 2140.

### Gyroscope Mechanism

A gyroscope is a device for maintaining orientation, based on the principle of conservation of angular momentum. The essence of the device is a spinning mass on an axle. The mass, once spinning, tends to resist changes to its orientation due to the angular momentum of the mass. In physics this phenomenon is also known as gyroscopic inertia or rigidity in space.

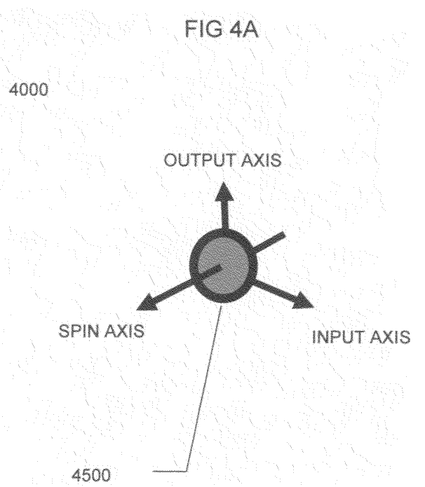

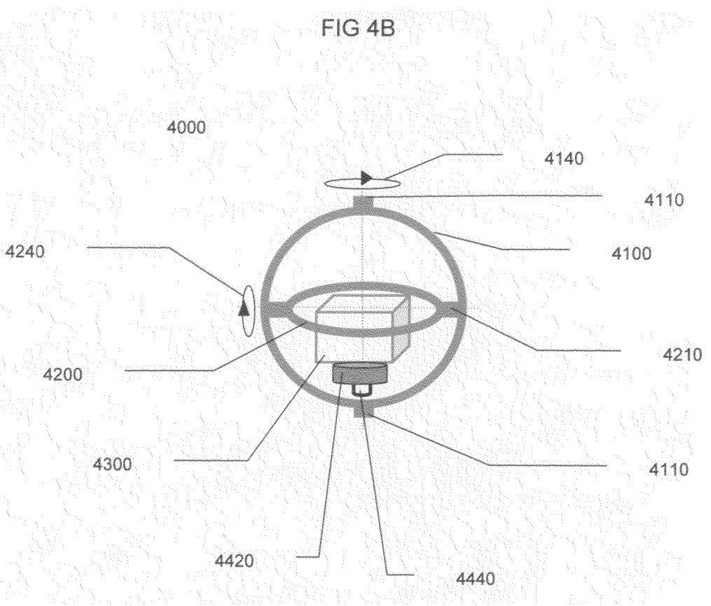

With reference to FIG. 4, a gyroscope 4000 is shown with a gyroscope wheel or rotor 4500. Reaction arrows are shown about the output corresponding to forces applied about the input axis, and vice versa

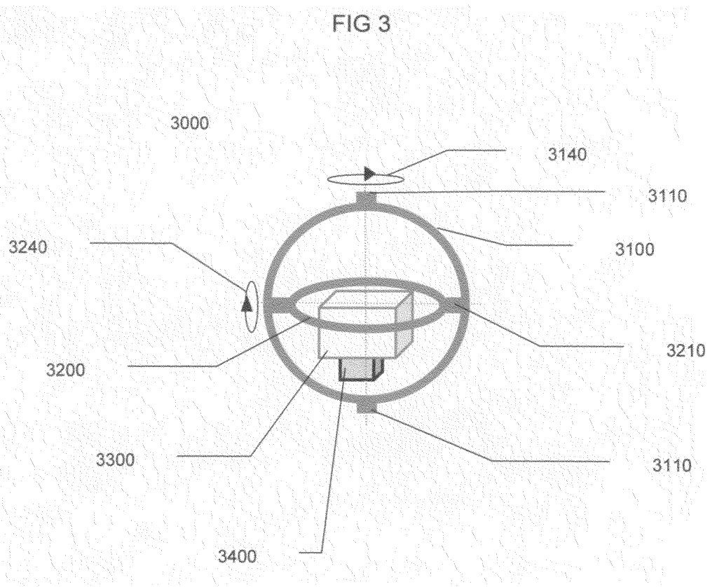

With reference to FIG. 3 and FIG. 4A, the rotor is journaled to spin about one axis, the journals configured so that the inner frame 3200 and the outer frame 3100 of FIG. 3 serve as gimbals of the gyroscope 4000 as depicted in FIG. 4A. As a result of the configuration the the rotor is effectively mounted in the inner frame or gimbal 3200, wherein the inner frame or gimbal 3200 is journaled for oscillation in the outer frame or gimbal 3100, which in turn is journaled for oscillation relative to supports 3110. The outer flame or gimbal or ring 3100 is mounted so as to pivot about an axis 3140 in its own plane determined by the supports 3110. The outer gimbal 3100 possesses one degree of rotational freedom 3140 and its axis possesses none. The inner gimbal 3200 is mounted in the outer gimbal 3100 so as to pivot 3240 about an axis in its own plane, which axis is always normally to the pivotal axis of the outer gimbal 3100.

With reference to FIG. 4A, the axle of the spinning rotor 4500 defines the spin axis. In FIG. 3, the inner gimbal 3200 possesses two degrees of rotational freedom and its axis possesses one. The rotor 4500 in FIG. 4A is journaled to spin about an axis which is always normal to the axis of the inner gimbal 3200 in FIG. 3. Hence the rotor 4500 in FIG. 4A possesses three degrees of rotational freedom and its axis possesses two. The rotor 4500 in FIG. 4A responds to a force applied about the input axis by a reaction force about the output axis. The 3 axes are perpendicular, and this cross-axis response is the simple essence of the gyroscopic effect.

The fundamental equation describing the behavior of the gyroscope is:

$$τ = \frac{d L}{d t} = \frac{d ( I ω )}{d t} = I α \qquad [ 1 ]$$

where the vectors τ and L are, respectively, the torquee on the gyroscope and its angular momentum, the scalar I is its moment of inertia, the vector ω is its angular velocity, and the vector α is its angular acceleration.

It follows from this that a torque τ applied perpendicular to the axis of rotation, and therefore perpendicular to L, results in a motion perpendicular to both τ and L. This motion is called precession. The angular velocity of precession Ω_{P} is given by the cross product:

τ=Ω_{P}×L [2]

Precession can be demonstrated by placing a spinning gyroscope with its axis horizontal and supported loosely (frictionless toward precession) at one end. Instead of falling or tipping over, as might be expected, the gyroscope appears to defy gravity by remaining with its axis horizontal, when the other end of the axis is left unsupported and the free end of the axis slowly describes a circle in a horizontal plane, the resulting precession turning. This effect is explained by the above equations [1] and [2]. The torque on the gyroscope is supplied by a couple of forces: gravity acting downwards on the device's centre of mass, and an equal force acting upwards to support one end of the device. The motion resulting from this torque is not downwards, as might be intuitively expected, causing the device to fall, but perpendicular to both the gravitational torque (downwards) and the axis of rotation (outwards from the point of support), i.e. in a forward horizontal direction, causing the device to rotate slowly about the supporting point.

As equation [2] shows, under a constant torque due to gravity or not, the gyroscope's speed of precession is inversely proportional to its angular momentum.

### Gyroscope Mounting

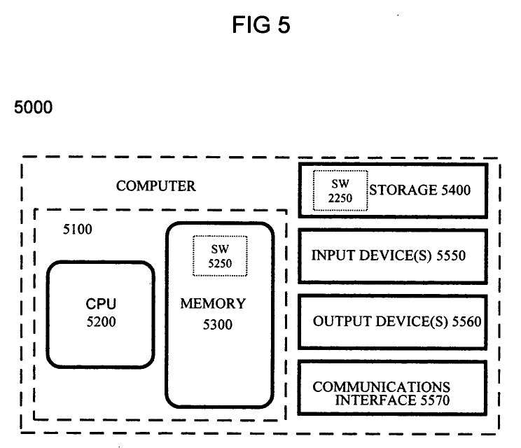

With reference to FIG. 4B, the rotor 4420 may be mounted beneath the rider compartment 4300 so that the rotor 4420 spins on a axis that passes through the centroid of the rider's compartment 4300. A motor 4440 driving the rotor 4420 may be mounted beneath the rotor 4420. A computer such as illustrated in FIG. 5 is housed within the rider's compartment 4300.

### Controlled Motion of the Rider

With reference to FIG. 3, the gyroscope mechanism is further equipped with a motor for turning the rotor 4500 shown in FIG. 4A. The rotational speed of the motor and the rotor's angular momentum in turn is controlled by a computer as depicted in FIG. 5.

The transport mechanism and the track for transport are made to carry electricity to the motor so that the motor may, under control of the computer precess or wobble as required by the computer program. The degree or extent of the precession, coupled with the up, down, and sideways motion caused by the tracks provide the motion experienced by the rider.

### Computer Control System

With reference to FIG. 5, the gyroscope controller is implemented; for example, within a computing environment 5000, which includes at least one processing unit 5200 and memory 5300. In FIG. 5, this most basic configuration 5000 is included within 5100 a dashed line. The processing unit 5200 executes computer-executable instructions and may be a real or a virtual processor. In a multi-processing system, multiple processing units execute computer-executable instructions to increase processing power. The memory 5300 may be volatile memory (e.g., registers, cache, RAM), non-volatile memory (e.g., ROM, EEPROM, flash memory, etc.), or some combination of the two. The memory 5300 stores executable software—instructions and data 5250—written and operative to execute and implement the software applications required to support the interactive environment of the invention.

The computing environment may have additional features. For example, the computing environment 5000 includes storage 5400, one or more input devices 5550, one or more output devices 5560, and one or more communication connections or interfaces 5570. An interconnection mechanism (not shown) such as a bus, controller, or network interconnects the components of the computing environment, for example with the servo-mechanisms and sensor device. Typically, operating system software (not shown) provides an operating environment for other software executing in the computing environment, and coordinates activities of the components of the computing environment.

The storage 5400 may be removable or non-removable, and includes magnetic disks, CD-ROMs, DVDs, or any other medium which can be used to store information and which can be accessed within the computing environment. The storage 5400 also stores instructions for the software 5250, and is configured, for example, to store signal processing algorithms, intermediate results and data generated from sensor inputs.

The input device(s) 5550 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 5560 may be a display, printer, speaker, or another device that provides output from the computing environment.

The communication interface 5570 enable the operating system and software applications to exchange messages over a communication medium 5600 with the sensor device, servo-mechanism and monitor. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The computer system 5000 is programmed to control the angular momentum of the rotor 4500 (FIG. 4). The program is constructed to vary the angular momentum of the rotor according to the movement of the ride so that as the ride. The program is coded so as to control the gyration of the rider compartment within limits dictated by the safety of the rider, or is coded to maintain a desired level of comfort and safety and yet to provide thrills to those riding.

For example, the program may control the motion of the rider according to the position of the ride on the track or may control the motion of the rider according to a random process, while keeping the motion within safe limits.

### Spherical Transport

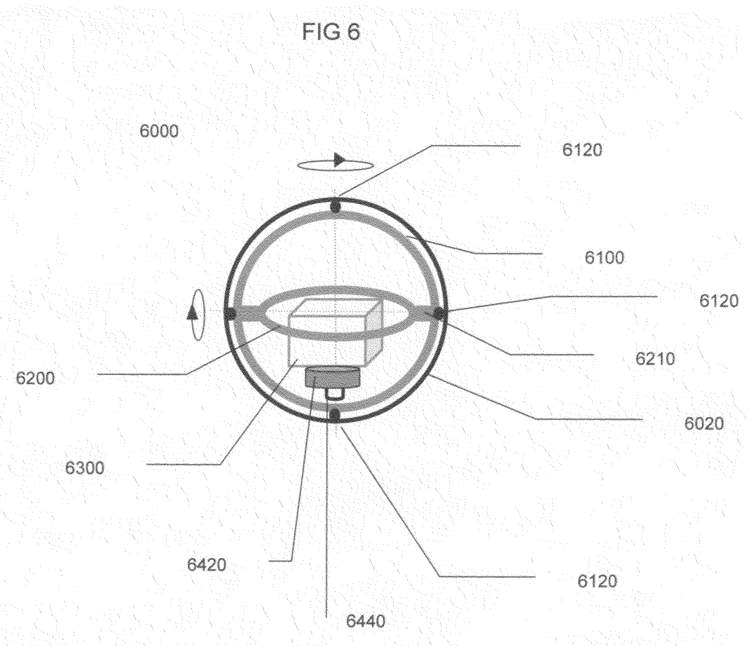

Referring to FIG. 6, the gimbal mechanism 6100, 6200 is mounted within a spherical enclosure 6020. The gimbal mechanism's outer frame 6100 is held by mounts or pivots 6110 having bearings configured to permit the outer frame 6100 to rotate about a vertical axis. The outer frame 6100 may further have bearings, such as 6120 to permit the outer frame 6100 to move freely within the enclosure 6020. By properly configuring the gimbal mechanism with bearings 6120, the gimbal mechanism may spin or rotate or move according to computer control as the spherical transport rolls within and along a track made to accommodate the spherical transport.

### Further Illustrations of the Exemplary Embodiment and the Alternative Embodiments

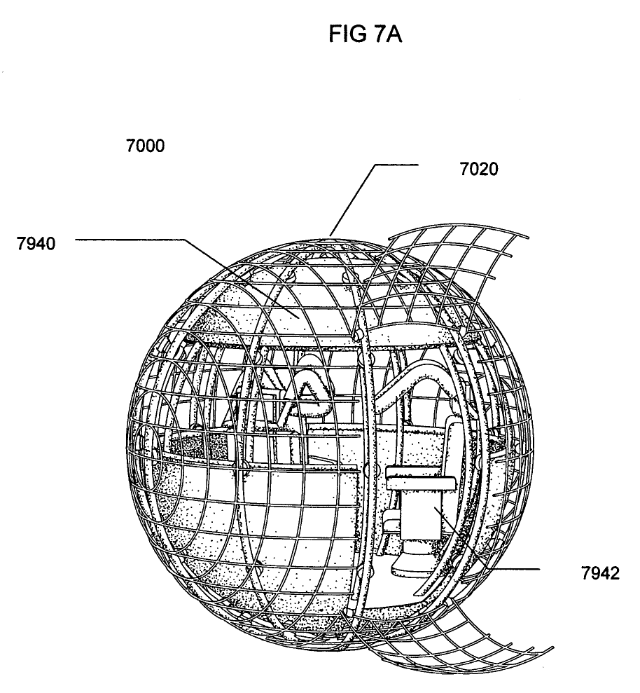

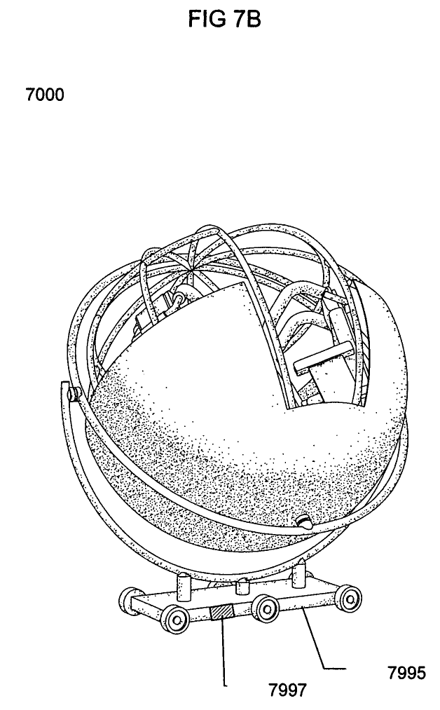

With reference to FIG. 7A, the gimbal arrangement (refer to is mounted within an enclosing compartment 7940, wherein a rider seat 7942 is mounted. The enclosing compartment 7940 is further mounted within a spherical cage 7020 that rolls within a containing track.

With reference to FIG. 7B, the gimbal arrangement is mounted on a traditional roller coaster car 7995. The car 7995 may be moved along tracks by a linear motor 7997. The linear motor 7997 is essentially a multi-phase ac electric motor that has had its stator “unrolled” so that instead of producing a torque (rotation), it produces a linear force along its length. The most common mode of operation is as a Lorenz-type actuator, in which the applied force is linearly proportional to the current and the magnetic field (F=i×B). The linear motor 7997 receives power from conductors placed along the track and converts electrical energy into magnetic power to move the car 7995 along the track.

### DISCLOSURE SUMMARY

An exemplary embodiment of the invention has been disclosed. It will be appreciated that the embodiment is directed to a ride that provides thrills and excitement to riders.

It will be appreciated that other variations and embodiments are possible in view of the disclosure made and that the full scope and description of the invention is given by the claims that follow.

I claim:

1. A roller coast riding mechanism, the mechanism comprising:
a gimbal arrangement, the gimbal arrangement configured to hold a rider, the motion of the gimbal arrangement dictated by a gyroscope having a rotor, the gyroscope rotor controlled by a motor, wherein the motor is controlled by a computer;
whereby the motion of the rider is determined in part by the computer.

2. The mechanism of claim 1, wherein the gimbal mechanism is contained within a sphere, the sphere rolling within or along a track according to gravitational forces.

3. The mechanism of claim 1, wherein the gimbal mechanism is attached to a car rolling within or a long a track according to gravitational forces.

4. The mechanism of claim 1, wherein the gimbal mechanism is contained within a sphere, the sphere rolling within or along a track according to the action of a linear motor.
